(19) United States
(12) Patent Application Publication
(10) Pub. No.: US 2009/0323824 A1
(43) Pub. Date: Dec. 31, 2009

(54) Methods and Apparatus for Use in Multi-View Video Coding

(76) Inventors: Purvin Bibhas Pandit, Franklin Park, NJ (US); Yeping Su, Vancouver, WA (US); Peng Yin, West Windsor, NJ (US); Cristina Gomila, Princeton, NJ (US)

Correspondence Address: Robert D. Shedd, Patent Operations;THOMSON Licensing LLC, P.O. Box 5312, Princeton, NJ, 08543-5312, US

(21) Appl. No.: 12/309,210

(22) PCT Filed: May 30, 2007
(86) PCT No.: PCT/US2007/012849

§ 371 Date: Jan. 9, 2009

Related U.S. Application Data
(60) Provisional application No. 60/830,206, filed on Jul. 11, 2006.

(51) Int. Cl. H04N 7/26

(52) U.S. Cl. 375/240.26; 375/E07.026

(57) ABSTRACT

There are provided methods and apparatus for use in multi-view video coding. An apparatus includes an encoder for encoding anchor and non-anchor pictures for at least two views corresponding to multi-view video content, wherein a dependency structure of each non-anchor picture in a set of non-anchor pictures disposed between a previous anchor picture and a next anchor picture in display order in at least one of the at least two views is the same as the previous anchor picture or the next anchor picture in display order.

### CROSS-REFERENCE TO RELATED APPLICATIONS

This application claims the benefit of U.S. Provisional Application Ser. No. 60/830,206, filed 11 Jul. 2006, which is incorporated by reference herein in its entirety.

### TECHNICAL FIELD

The present principles relate generally to video encoding and decoding and, more particularly, to methods and apparatus for use in Multi-view Video Coding (MVC).

### BACKGROUND

In the current implementation of Multi-view Video Coding (MVC) compliant with the International Organization for Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 recommendation (hereinafter the “MPEG-4 AVC standard”), there is no provision to identify a specific view and to signal the camera parameters. This view information is needed for several reasons. View scalability, view random access, parallel processing, view generation, and view synthesis are all Multi-view Video Coding requirements which utilize the view id information. Moreover, several of these requirements also utilize camera parameters which are currently not passed in a standardized way.

In a first prior art approach, a method is proposed to enable efficient random access in multi-view compressed bit streams. In the proposed method, a new V-picture type and a new View Dependency SEI message are defined. A feature required in the proposed V-picture type is that V-pictures shall have no temporal dependence on other pictures in the same camera and may only be predicted from pictures in other cameras at the same time. The proposed View Dependency SEI message will describe exactly which views a V-picture, as well as the preceding and following sequence of pictures, may depend on. The following are the details of the proposed changes.

With respect to V-Picture syntax and semantics, a particular syntax table relating to the MPEG-4 AVC standard is extended to include a Network Abstraction Layer (NAL) unit type of 14 corresponding to a V-picture. Also, the V-picture type is defined to have the following semantics:

V-picture: A coded picture in which all slices reference only slices with the same temporal index (i.e., only slices in other views and not slices in the current view). When a V-picture would be output or displayed, it also causes the decoding process to mark all pictures from the same view which are not IDR-pictures or V-pictures and which precede the V-picture in output order to be marked as “unused for reference”. Each V-picture shall be associated with a View Dependency SEI message occurring in the same NAL.

With respect to the view dependency Supplemental Enhancement Information message syntax and semantics, a View Dependency Supplemental Enhancement Information message is defined with the following syntax:

```
view_dependency ( payloadSize ) {
  num_seq_reference_views ue(v)
  seq_reference_view_0 ue(v)
  seq_reference_view_1 ue(v)
  ...
  seq_reference_view_N ue(v)
  num_pic_reference_views ue(v)
  pic_reference_view_0 ue(v)
  pic_reference_view_1 ue(v)
  ...
  pic_reference_view_N ue(v)
}
```

where num_seq_reference_views/num_pic_reference_views denotes the number of potential views that can be used as a reference for the current sequence/picture, and seq_reference_view_i/pic_reference_view_i denotes the view number for the i^{th} reference view.

The picture associated with a View Dependency Supplemental Enhancement Information message shall only reference the specified views described by pic_reference_view_i. Similarly, all subsequent pictures in output order of that view until the next View Dependency Supplemental Enhancement Information message in that view shall only reference the specified views described by seq_reference_view_i.

A View Dependency Supplemental Enhancement Information message shall be associated with each Instantaneous Decoding Refresh (IDR) picture and V-picture.

The first prior art method has the advantage of handling cases where the base view can change over time, but it requires additional buffering of the pictures before deciding which pictures to discard. Moreover, the first prior art method has the disadvantage of having a recursive process to determine the dependency.

### SUMMARY

These and other drawbacks and disadvantages of the prior art are addressed by the present principles, which are directed to methods and apparatus for use in Multi-view Video Coding (MVC).

According to an aspect of the present principles, there is provided an apparatus. The apparatus includes an encoder for encoding anchor and non-anchor pictures for at least two views corresponding to multi-view video content. A dependency structure of each non-anchor picture in a set of non-anchor pictures disposed between a previous anchor picture and a next anchor picture in display order in at least one of the at least two views is the same as the previous anchor picture or the next anchor picture in display order.

According to another aspect of the present principles, there is provided a method. The method includes encoding anchor and non-anchor pictures for at least two views corresponding to multi-view video content. A dependency structure of each non-anchor picture in a set of non-anchor pictures disposed between a previous anchor picture and a next anchor picture in display order in at least one of the at least two views is the same as the previous anchor picture or the next anchor picture in display order.

According to yet another aspect of the present principles, there is provided an apparatus. The apparatus includes a decoder for decoding anchor and non-anchor pictures for at least two views corresponding to multi-view video content. A dependency structure of each non-anchor picture in a set of non-anchor pictures disposed between a previous anchor picture and a next anchor picture in display order in at least one of the at least two views is the same as the previous anchor picture or the next anchor picture in display order.

According to still yet another aspect of the present principles, there is provided a method. The method includes decoding anchor and non-anchor pictures for at least two views corresponding to multi-view video content. A dependency structure of each non-anchor picture in a set of non-anchor pictures disposed between a previous anchor picture and a next anchor picture in display order in at least one of the at least two views is the same as the previous anchor picture or the next anchor picture in display order.

According to a further aspect of the present principles, there is provided an apparatus. The apparatus includes a decoder for decoding at least two views corresponding to multi-view video content from a bitstream. At least two Groups of Pictures corresponding to one or more of the at least two views have a different dependency structure. The decoder selects pictures in the at least two views that are required to be decoded for a random access of at least one of the at least two views based upon at least one dependency map.

According to a yet further aspect of the present principles, there is provided a method. The method includes decoding at least two views corresponding to multi-view video content from a bitstream. At least two Groups of Pictures corresponding to one or more of the at least two views have a different dependency structure. The decoding step selects pictures in the at least two views that are required to be decoded for a random access of at least one of the at least two views based upon at least one dependency map.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a block diagram for an exemplary Multi-view Video Coding (MVC) encoder to which the present principles may be applied, in accordance with an embodiment of the present principles;

FIG. 2 is a block diagram for an exemplary Multi-view Video Coding (MVC) decoder to which the present principles may be applied, in accordance with an embodiment of the present principles;

FIG. 3 is a diagram for an inter-view-temporal prediction structure based on the MPEG-4 AVC standard, using hierarchical B pictures, in accordance with an embodiment of the present principles;

FIG. 4 is a flow diagram for an exemplary method for encoding multiple views of multi-view video content, in accordance with an embodiment of the present principles;

FIG. 5 is a flow diagram for an exemplary method for decoding multiple views of multi-view video content, in accordance with an embodiment of the present principles;

FIG. 6A is a diagram illustrating an exemplary dependency change in non-anchor frames that have the same dependency as a later anchor slot, to which the present principles may be applied, in accordance with an embodiment of the present principles;

FIG. 6B is a diagram illustrating an exemplary dependency change in non-anchor frame that have the same dependency as a previous anchor slot, to which the present principles may be applied, in accordance with an embodiment of the present principles;

FIG. 7 is a flow diagram for an exemplary method for decoding multi-view video content using a random access point, in accordance with an embodiment of the present principles;

FIG. 8 is a flow diagram for another exemplary method for decoding multi-view content using a random access point, in accordance with an embodiment of the present principles; and

FIG. 9 is a flow diagram for an exemplary method for encoding multi-view video content, in accordance with an embodiment of the present principles.

### DETAILED DESCRIPTION

The present principles are directed to methods and apparatus for use in Multi-view Video Coding (MVC).

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment.

As used herein, “high level syntax” refers to syntax present in the bitstream that resides hierarchically above the macroblock layer. For example, high level syntax, as used herein, may refer to, but is not limited to, syntax at the slice header level, Supplemental Enhancement Information (SEI) level, picture parameter set level, sequence parameter set level and NAL unit header level.

Also, as used herein, “anchor slot” refers to the time at which a picture is sampled from each view and each of the sampled pictures from each view is an anchor picture.

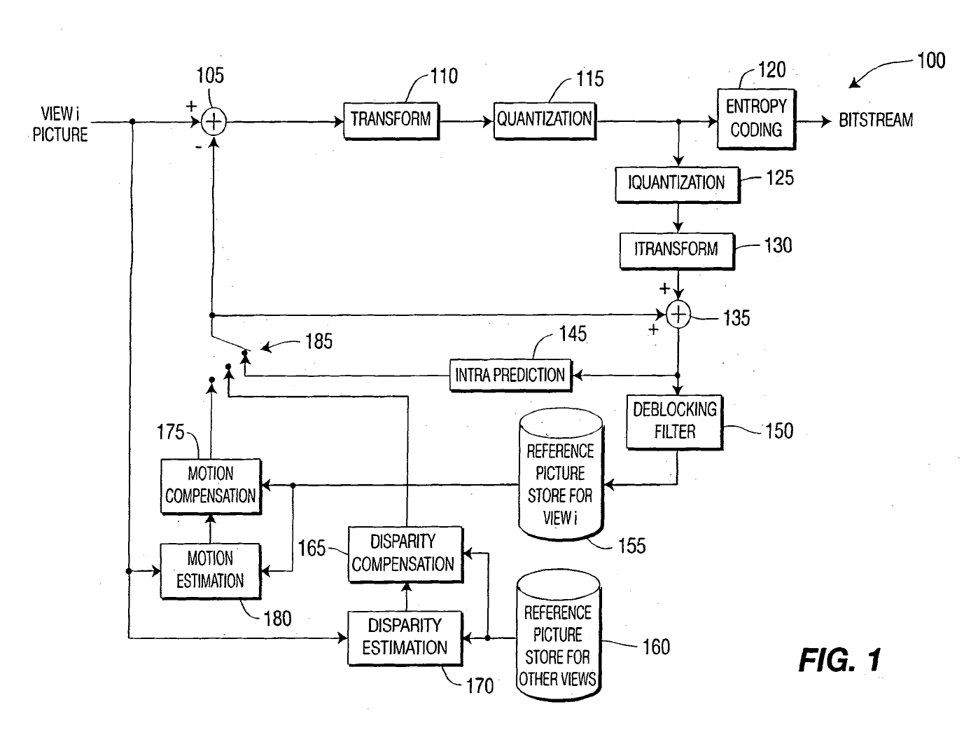

Turning to FIG. 1, an exemplary Multi-view Video Coding (MVC) encoder is indicated generally by the reference numeral 100. The encoder 100 includes a combiner 105 having an output connected in signal communication with an input of a transformer 110. An output of the transformer 110 is connected in signal communication with an input of quantizer 115. An output of the quantizer 115 is connected in signal communication with an input of an entropy coder 120 and an input of an inverse quantizer 125. An output of the inverse quantizer 125 is connected in signal communication with an input of an inverse transformer 130. An output of the inverse transformer 130 is connected in signal communication with a first non-inverting input of a combiner 135. An output of the combiner 135 is connected in signal communication with an input of an intra predictor 145 and an input of a deblocking filter 150. An output of the deblocking filter 150 is connected in signal communication with an input of a reference picture store 155 (for view i). An output of the reference picture store 155 is connected in signal communication with a first input of a motion compensator 175 and a first input of a motion estimator 180. An output of the motion estimator 180 is connected in signal communication with a second input of the motion compensator 175

An output of a reference picture store 160 (for other views) is connected in signal communication with a first input of a disparity estimator 170 and a first input of a disparity compensator 165. An output of the disparity estimator 170 is connected in signal communication with a second input of the disparity compensator 165.

An output of the entropy decoder 120 is available as an output of the encoder 100. A non-inverting input of the combiner 105 is available as an input of the encoder 100, and is connected in signal communication with a second input of the disparity estimator 170, and a second input of the motion estimator 180. An output of a switch 185 is connected in signal communication with a second non-inverting input of the combiner 135 and with an inverting input of the combiner 105. The switch 185 includes a first input connected in signal communication with an output of the motion compensator 175, a second input connected in signal communication with an output of the disparity compensator 165, and a third input connected in signal communication with an output of the intra predictor 145.

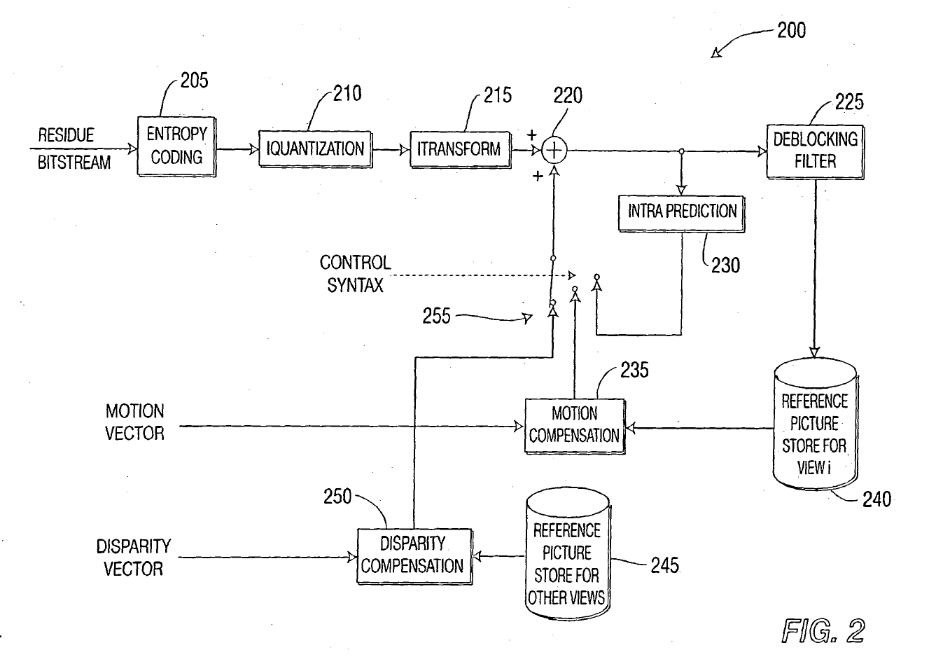

Turning to FIG. 2, an exemplary Multi-view Video Coding (MVC) decoder is indicated generally by the reference numeral 200. The decoder 200 includes an entropy decoder 205 having an output connected in signal communication with an input of an inverse quantizer 210. An output of the inverse quantizer is, connected in signal communication with an input of an inverse transformer 215. An output of the inverse transformer 215 is connected in signal communication with a first non-inverting input of a combiner 220. An output of the combiner 220 is connected in signal communication with an input of a deblocking filter 225 and an input of an intra predictor 230. An output of the deblocking filter 225 is connected in signal communication with an input of a reference picture store 240 (for view i). An output of the reference picture store 240 is connected in signal communication with a first input of a motion compensator 235.

An output of a reference picture store 245 (for other views) is connected in signal communication with a first input of a disparity compensator 250.

An input of the entropy coder 205 is available as an input to the decoder 200, for receiving a residue bitstream. Moreover, a control input of the switch 255 is also available as an input to the decoder 200, for receiving control syntax to, control which input is selected by the switch 255. Further, a second input of the motion compensator 235 is available as an input of the decoder 200, for receiving motion vectors. Also, a second input of the disparity compensator 250 is available as an input to the decoder 200, for receiving disparity vectors.

An output of a switch 255 is connected in signal communication with a second non-inverting input of the combiner 220. A first input of the switch 255 is connected in signal communication with an output of the disparity compensator 250. A second input of the switch 255 is connected in signal communication with an output of the motion compensator 235. A third input of the switch 255 is connected in signal communication with an output of the intra predictor 230. An output of the mode module 260 is connected in signal communication with the switch 255 for controlling which input is selected by the switch 255. An output of the deblocking filter 225 is available as an output of the decoder.

In an embodiment of the present principles, a high level syntax is proposed for efficient processing of a multi-view sequence. In particular, we propose creating a new parameter set called View Parameter Set (VPS) with its own NAL unit type and two more new NAL unit types to support multi-view slices, with the NAL unit types including a view identifier (id) in the NAL header to identify to which view the slice belongs. For view scalability and backward compatibility With decoders compliant with the MPEG-4 AVC standard, we propose to maintain one MPEG-4 AVC compliant view which we call an “MPEG-4 AVC compliant Base View”.

As used herein, “high level syntax” refers to syntax present in the bitstream that resides hierarchically above the macroblock layer. For example, high level syntax, as used herein, may refer to, but is not limited to, syntax at the slice header level, Supplemental Enhancement Information (SEI) level, picture parameter set level, and sequence parameter set level.

In the current implementation of the Multi-view Video Coding system described above as having no provision to identify a specific view and to signal camera parameters different views are interleaved to form a single sequence instead of treating the different views as separate views. Since the syntax is compatible with the MPEG-4 AVC standard, as noted above, it is presently not possible to identify which view a given slice belongs to. This view information is needed for several reasons. View scalability, view random access, parallel processing, view generation, and view synthesis are all Multi-view Video Coding requirements which need to identify a view. For efficient support of view random access and view scalability, it is important for the decoder to know how different pictures depend on each other, so only pictures that are necessary are decoded. Camera parameters are needed for view synthesis. If view synthesis is eventually used in the decoding loop, a standardized way of signaling camera parameters needs to be specified. In accordance with an embodiment, a view parameter set is used.

In an embodiment, it is presumed that one view is needed that is fully backward compatible with the MPEG-4 AVC standard for the purpose of supporting non-MVC compatible but MPEG-4 AVC compatible decoders. In an embodiment, it is presumed that there will be views that are independently decodable to facilitate fast view random access. We refer to these views as “base views”. A base view may or may not be compatible with the MPEG-4 AVC standard, but an MPEG-4 AVG compatible view is always a base view.

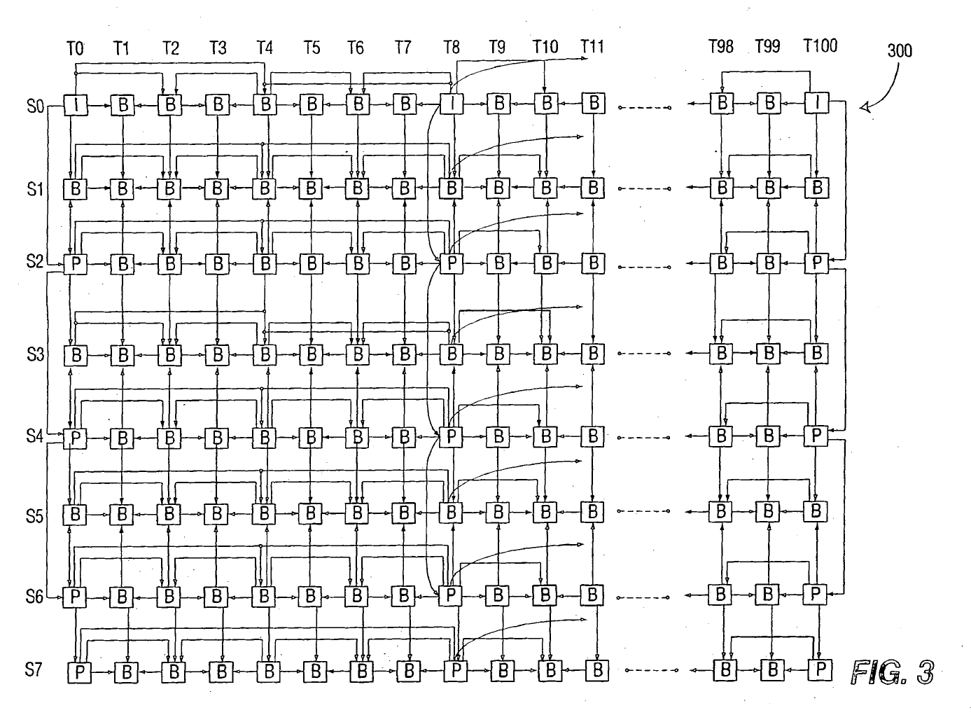

Turning to FIG. 3, an inter-view-temporal prediction structure based on the MPEG-4 AVC standard, using hierarchical B pictures, is indicated generally by the reference numeral 300. In FIG. 3, the variable I denotes an intra coded picture, the variable P denotes a predictively coded picture, the variable B denotes a bi-predictively coded picture, the variable T denotes a location of a particular picture, and the variable S denotes a particular view to which corresponds a particular picture.

In accordance with an embodiment, the following terms are defined.

An “anchor picture” is defined as a picture the decoding of which does not involve any picture sampled at a different time instance. An anchor picture is signaled by setting the nal_ref_idc to 3. In FIG. 3, all pictures in locations T0, T8 . . . , T96, and T100 are examples of anchor pictures.

A “non-anchor picture” is defined as a picture which does not have the above constraint specified for an anchor picture. In FIG. 3, pictures B2, B3, and B4 are non-anchor pictures.

A “base view” is a view which does not depend on any other view and can be independently decoded. In FIG. 3, view S0 is an example of base view.

Also, in an embodiment, a new parameter set is proposed called the View Parameter Set with its own NAL unit type and two new NAL unit types to support Multi-view Video Coding slices. We also modify the slice header syntax to indicate the view_id and the view parameter set to be used.

The MPEG-4 AVC standard includes the following two parameter sets: (1) Sequence Parameter Set (SPS), which includes information that is not expected to change over an entire sequence; and (2) Picture Parameter Set (PPS), which includes information that is not expected to change for each picture.

Since Multi-view Video Coding has additional information which is specific to each view, we have created a separate View Parameter Set (VPS) in order to transmit this information. All the information that is needed to determine the dependency between the different views is indicated in the View Parameter Set. The syntax table for the proposed View Parameter Set is shown in TABLE 1 (View Parameter Set RBSP syntax). This View Parameter Set is included in a new NAL unit type, for example, type 14 as shown in TABLE 2 (NAL unit type codes).

In accordance with the description of the present invention, the following terms are defined:

view_parameter_set_id identifies the view parameter set that is referred to in the slice header. The value of the view_parameter_set_id shall be in the range of 0, to 255.

number_of_views_minus_{—}1 plus 1 identifies the total number of views in the bitstream. The value of the number_of_view_minus_{—}1 shall be in the range of 0 to 255.

avc_compatible_view_id indicates the view_id of the AVC compatible view. The value of avc_compatible_view_id shall be in the range of 0 to 255.

is_base_view_flag[i] equal to 1 indicates that the view i is a base view and is independently decodable. is_base_view_flag[i] equal to 0 indicates that the view i is not a base view. The value of is_base_view_flag[i] shall be equal to 1 for an AVC compatible view i.

dependency_update_flag equal to 1 indicates that dependency information for this view is updated in the VPS. dependency_update_flag equal to 0 indicates that the dependency information for this view is not updated and should not be changed.

anchor_picture_dependency_maps[i][j] equal to 1 indicates the anchor pictures with view_id equal to j will depend on the anchor pictures with view_id equal to i.

non_anchor_picture_dependency_maps[i][j] equal to 1 indicates the non-anchor pictures with view_id equal to j will depend on the non-anchor pictures with view_id equal to i. non_anchor_picture_dependency_maps[i][j] is present only when anchor picture_dependency maps[i][i] equals 1. If anchor_picture_dependency_maps[i][j] is present and is equal to zero non_anchor_picture_dependency_maps[i][j] shall be inferred as being equal to 0.

TABLE 1

| view_parameter_set_rbsp( ) { | C | Descriptor |
|---|---|---|
| view_parameter_set_id | 0 | ue(v) |
| number_of_views_minus_1 | 0 | ue(v) |
| avc_compatible_view_id | 0 | ue(v) |
| for( i = 0; i <= number_of_views_minus_1; i++ ) { | | |
| is_base_view_flag[i] | 0 | u(1) |
| dependency_update_flag | 0 | u(1) |
| if (dependency_update_flag == 1) { | | |
| for(j = 0; j <= number_of_views_minus_1; j++) { | | |
| anchor_picture_dependency_maps[i][j] | 0 | f(1) |
| if (anchor_picture_dependency_maps[i][j] == 1) | | |
| non_anchor_picture_dependency_maps[i][j] | 0 | f(1) |
| } | | |
| } | | |
| } | | |
| for( i = 0; i <= number_of_views_minus_1; i++ ) { | | |
| camera_parameters_present_flag | 0 | u(1) |
| if (camera_parameters_present_flag == 1) { | | |
| camera_parameters_1_1[i] | 0 | f(32) |
| *** | | |
| camera_parameters_3_4[i] | 0 | f(32) |
| } | | |
| } | | |
| } | | |

TABLE 2

| nal_unit_type | Content of NAL unit and RBSP syntax structure | C |
|---|---|---|
| 0 | Unspecified | |
| 1 | Coded slice of a non-IDR picture | 2, 3, 4 |
| | slice_layer_without_partitioning_rbsp( ) | |
| 2 | Coded slice data partition A | 2 |
| | slice_data_partition_a_layer_rbsp( ) | |
| 3 | Coded slice data partition B | 3 |
| | slice_data_partition_b_layer_rbsp( ) | |
| 4 | Coded slice data partition C | 4 |
| | slice_data_partition_c_layer_rbsp( ) | |
| 5 | Coded slice of an IDR picture | 2, 3 |
| | slice_layer_without_partitioning_rbsp( ) | |
| 6 | Supplemental enhancement information (SEI) | 5 |
| | sei_rbsp( ) | |
| 7 | Sequence parameter set | 0 |
| | seq_parameter_set_rbsp( ) | |
| 8 | Picture parameter set | 1 |
| | pic_parameter_set_rbsp( ) | |
| 9 | Access unit delimiter | 6 |
| | access_unit_delimiter_rbsp( ) | |
| 10 | End of sequence | 7 |
| | end_of_seq_rbsp( ) | |
| 11 | End of stream | 8 |
| | end_of_stream_rbsp( ) | |
| 12 | Filler data | 9 |
| | filler_data_rbsp( ) | |
| 13 | Sequence parameter set extension | 10 |
| | seq_parameter_set_extension_rbsp( ) | |
| 14 | View parameter set | 11 |
| | view_parameter_set_rbps( ) | |
| 15 . . . 18 | Reserved | |
| 19 | Coded slice of an auxiliary coded picture without partitioning | 2, 3, 4 |
| | slice_layer_without_partitioning_rbsp( ) | |
| 20 | Coded slice of a non-IDR picture in scalable extension | 2, 3, 4 |
| | slice_layer_in_scalable_extension_rbsp( ) | |
| 21 | Coded slice of an IDR picture in scalable extension | 2, 3 |
| | slice_layer_in_scalable_extension_rbsp( ) | |
| 22 | Coded slice of a non-IDR picture in multi-view extension | 2, 3, 4 |
| | slice_layer_in_mvc_extension_rbsp( ) | |
| 23 | Coded slice of an IDR picture in multi-view extension | 2, 3 |
| | slice_layer_in_mvc_extension_rbsp( ) | |
| 24 . . . 31 | Unspecified | |

Optional parameters in the View Parameter Set include the following:

camera_parameters_present_flag equal to 1 indicates that a projection matrix is signaled as follows.

camera_parameters, presuming a camera parameter is conveyed in the form of a 3×4 projection matrix P, which can be used to map a point in the 3D world to the 2D image coordinate: I=P*[X_{w}:Y_{w}:Z_{w}:1], where I is in homogeneous coordinates I=[λ·Iₓ:λ·I_{y}:λ].

Each element camera_parameters_*_* can be represented according to the IEEE single precision floating point (32 bits) standard.

The advantage of putting this information in a separate parameter set is that we still maintain Sequence Parameter Sets (SPS) and Picture Parameter Sets (PPS) that are compatible with the MPEG-4 AVC standard. If we put this information in a Sequence Parameter Set or a Picture Parameter Set then, for each view, we need to send a separate Sequence Parameter Set and Picture Parameter Set. This is too restrictive. Also, this information does not fit well in either a Sequence Parameter Set or a Picture Parameter Set. Another reason is that since we propose to have an MPEG-4 AVC standard compatible base view we would have to use separate (MPEG-4 AVC compatible) Sequence Parameter Sets and Picture Parameter Sets for such a view and a separate Sequence Parameter Sets/Picture Parameter Sets (with view specific information) for all other views.

Placing all the dependency information in a single View Parameter Set at the very beginning of the sequence is very beneficial. The decoder can create a map using all the dependency information once it receives the View Parameter Set. This enables it to know before it receives any slice which views are needed for decoding a particular view. As a result of this, we only need to parse the slice header to obtain the view_id and determine if this view is needed to decode a target view as indicated by a user. Thus, we do not need to buffer any frames or wait until a certain point to determine which frames are needed for decoding a particular view.

The dependency information and whether it is a base view is indicated in the View Parameter Set. Even an MPEG-4 AVC compatible base view has associated with it information that is specific to that view (e.g., camera parameters). This information may be used by other views for several purposes including view interpolation/synthesis. We propose to support only one MPEG-4 AVC compatible view since if there are multiple MPEG-4 AVC compatible views, this makes it difficult to identify for each such slice which view it belongs to and a non-Multi-view Video Coding decoder can easily get confused.

By restricting it to just one such view, it is guaranteed that a non-Multi-view Video Coding decoder will be able to correctly decode the view and a Multi-view Video Coding decoder can easily identify such a view from the View Parameter Set using the syntax avc_compatible_view_id. All other base views (non-MPEG-4 AVC compatible) can be identified using the is_base_view_flag.

A new slice header for Multi-view Video Coding slices is proposed. In order to support view scalability, view random access, and so forth, we need to know which views the current slice depends upon. For view synthesis and view interpolation we may potentially also need camera parameters. This information is present in the View Parameter Set as shown above in TABLE 1. The View Parameter Set is identified using the view_parameter_set_id. We propose to add the view_parameter_set_id in the slice header of all the non-MPEG-4 AVC compatible slices as shown in TABLE 3 (Slice Header Syntax). The view_id information is needed for several Multi-view Video Coding requirements including view interpolation/synthesis, view random access, parallel processing, and so forth. This information can also be useful for special coding modes that only relate to cross-view prediction. In order to find the corresponding parameters from the View Parameter Set for this view, we need to send the view_id in the slice header.

TABLE 3

| slice_header( ) { | C | Descriptor |
|---|---|---|
| first_mb_in_slice | 2 | ue(v) |
| slice_type | 2 | ue(v) |
| pic_parameter_set_id | 2 | ue(v) |
| if (nal_unit_type == 22 \|\| nal_unit_type == 23) { | | |
| view_parameter_set_id | 2 | ue(v) |
| view_id | 2 | ue(v) |
| } | | |
| frame_num | 2 | u(v) |
| if( !frame_mbs_only_flag ) { | | |
| field_pic_flag | 2 | u(1) |
| if( field_pic_flag ) | | |
| bottom_field_flag | 2 | u(1) |
| } | | |
| ........ | | |
| } | | |

For the new Multi-view Video Coding slices we propose to create new NAL unit types for each slice type (Instantaneous Decoding Refresh (IDR) and non-IDR). We propose to use type 22 for IDR slices and type 23 for non-IDR slices as shown in TABLE 2.

view_parameter_set_id specifies the view parameter set in use. The value of the view_parameter_set_id shall be in the range 0 to 255.

view_id indicates the view id of the current view. The value of the view_parameter_set_id shall be in the range 0 to 255.

An example of view random access will now be described in accordance with an embodiment of the present principles.

View random access is a Multi-view Video Coding requirement. The goal is to get access to any view with minimum decoding effort. Let us consider a simple example of view random access for the prediction structure shown in FIG. 3.

Suppose a user requests to decode view S3. From FIG. 3, we see that this view depends on view S0, view S2, and view S4. An example View Parameter Set is illustrated below.

Let us presume that the view_id for the views are numbered consecutively from 0 to 7 in the slice header syntax and there is only one View Parameter Set present with view_parameter_set equal to 0. number_of_views_minus_{—}1 is set to 7. avc_compatible_view_id could be set to 0.

For views S0, is_base_view_flag is set to 1 and for other views it is set to 0. The dependency map for S0, S1, S2, S3, and S4 will look as shown in TABLE 4A (Dependency table for S0 anchor_picture_dependency_map) and TABLE 4B (dependency table for S0 non_anchor_picture_dependency_map). The dependency map for the other views can be written in a similar way.

Once this table is available at the decoder, the decoder can easily determine if a slice it receives is needed to decode a particular view. The decoder only needs to parse the slice header to determine the view_id of the current slice and for the target view S3 it can look up the S3 columns in the two tables (TABLE 4a and TABLE 4B) to determine whether or not it should keep the current slice. The decoder needs to distinguish between anchor pictures and non-anchor pictures since they may have different dependencies as can be seen from TABLE 4a and TABLE 4b. For the target view S3, we need to decode the anchor pictures of views S0, S2, and S4 but only need to decode the non-anchor pictures of views S2 and S4.

TABLE 4A

j

| i | S0 | S1 | S2 | S3 | S4 | S5 | S6 | S7 |
|---|---|---|---|---|---|---|---|---|
| S0 | 0 | 1 | 1 | 1 | 1 | 1 | 1 | 1 |
| S1 | 0 | 0 | 0 | 0 | 0 | 0 | 0 | 0 |
| S2 | 0 | 1 | 0 | 1 | 1 | 1 | 1 | 1 |
| S3 | 0 | 0 | 0 | 0 | 0 | 0 | 0 | 0 |
| S4 | 0 | 0 | 0 | 1 | 0 | 1 | 1 | 1 |

TABLE 4B

j

| i | S0 | S1 | S2 | S3 | S4 | S5 | S6 | S7 |
|---|---|---|---|---|---|---|---|---|
| S0 | 0 | 1 | 0 | 0 | 0 | 0 | 0 | 0 |
| S1 | 0 | 0 | 0 | 0 | 0 | 0 | 0 | 0 |
| S2 | 0 | 1 | 0 | 1 | 0 | 0 | 0 | 0 |
| S3 | 0 | 0 | 0 | 0 | 0 | 0 | 0 | 0 |
| S4 | 0 | 0 | 0 | 1 | 0 | 1 | 0 | 0 |

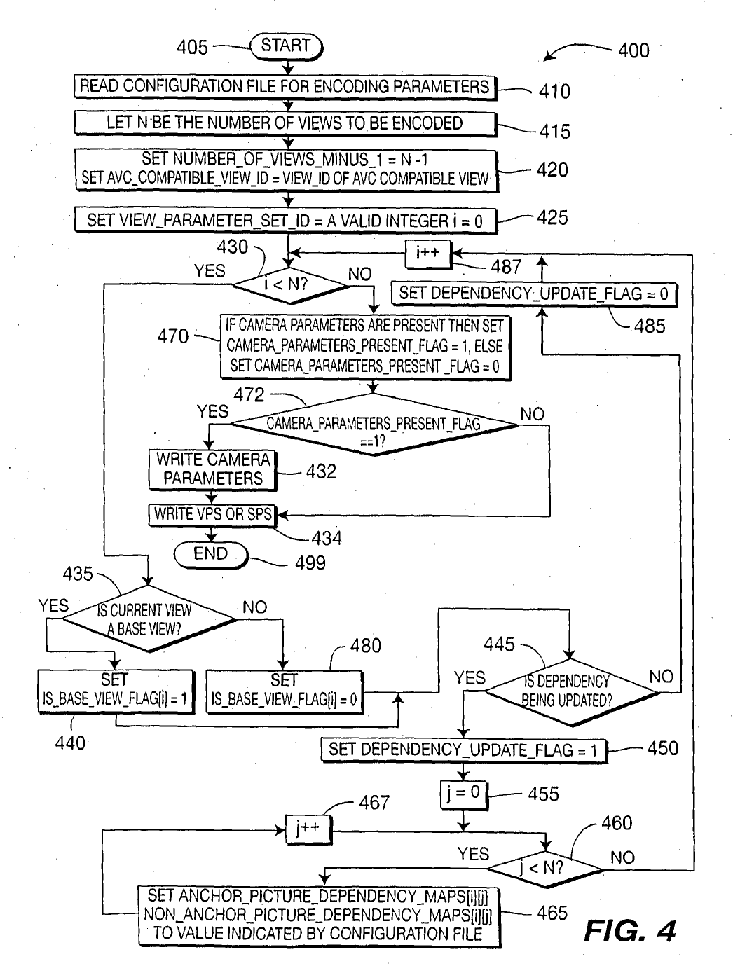

Turning to FIG. 4, an exemplary method for encoding multiple views of multi-view video content is indicated generally by the reference numeral 400.

The method 400 includes a start block 405 that passes control to a function block 410. The function block 410 reads a configuration file for the encoding parameters to be used to encode the multiple views, and passes control to a function block 415. The function block sets N to be equal to the number of views to be encoded, and passes control to a function block 420. The function block 420 sets number_of_views_minus_{—}1 equal to N−1, sets avc_compatible_view_id equal to the view_id of the MPEG-4 AVC compatible view, and passes control to a function block 425. The function block 425 sets view_parameter_set_id equal to a valid integer, initializes a variable i to be equal to zero, and passes control to a decision block 430. The decision block 430 determines whether or not i is greater than N. If so, then control is passed to a decision block 435. Otherwise, control is passed to a function block 470.

The decision block 435 determines whether or not the current view is a base view. If so, then control is passed to a function block 440. Otherwise, control is passed to a function block 480.

The function block 440 sets is_base_view_flag[i] equal to one, and passes control to a decision block 445. The decision block 445 determines whether or not the dependency is being updated. If so, the control is passed to a function block 450. Otherwise, control is passed to a function block 485.

The function block 450 sets dependency update flag equal to one, and passes control to a function block 455. The function block 455 sets a variable j equal to 0, and passes control to a decision block 460. The decision block 460 determines whether or not j is less than N. If so, then control is passed to a function block 465. Otherwise, control is passed to the function block 487.

The function block 465 sets anchor_picture_dependency_maps[i][j] and non_anchor_picture_dependency_maps[i][j] to values indicated by configuration file, and passes control to a function block 467. The function block 467 increments the variable j by one, and returns control to the decision block 460.

The function block 470 sets camera_parameters_present_flag equal to one when camera parameters are present, sets camera_parameters_present_flag equal to zero otherwise, and passes control to a decision block 472. The decision block 472 determines whether or not camera_parameters_present_flag is equal to one. If so, then control is passed to a function block 432. Otherwise, control is passed to a function block 434.

The function block 432 writes the camera parameters, and passes control to the function block 434.

The function block 434 writes the View Parameter Set (VPS) or the Sequence Parameter Set (SPS), and passes control to an end block 499.

The function block 480 sets is_base_view_flag[i] equal to zero, and passes control to the decision block 445.

The function block 485 sets dependency_update_flag equal to zero, and passes control to a function block 487. The function block 487 increments the variable i by 1, and returns control to the decision block 430.

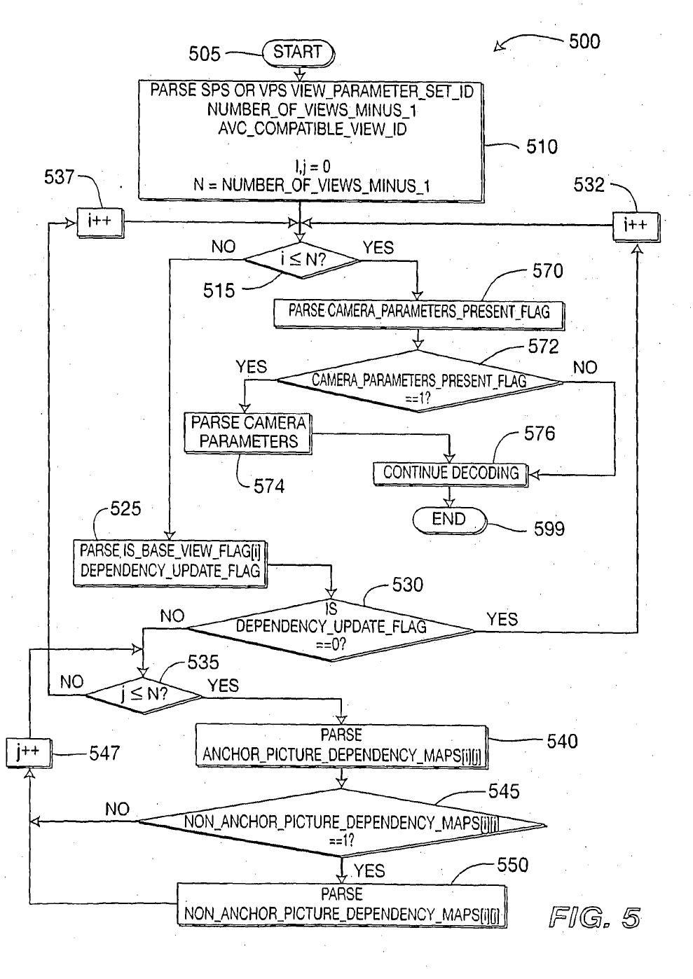

Turning to FIG. 5, an exemplary method for decoding multiple views of multi-view video content is indicated generally by the reference numeral 500.

The method 500 includes a start block 505 that passes control to a function block 510. The function block 510 parses a Sequence Parameter Set (SPS) or View Parameter Set (VPS), view_parameter_set_id, number_of_views_minus_{—}1, avc_compatible_view_id, sets variables I and j equal to zero, sets N equal to number_of_views_minus_{—}1, and passes control to a decision block 515. The decision block 515 determines whether or not i is less than or equal to N. If so, then control is passed to a function block 570. Otherwise, control is passed to a function block 525.

The function block 570 parses camera_parameters_present_flag, and passes control to a decision block 572. The decision block 572 determines whether or not camera_parameters_present_flag is equal to one. If so, then control is passed to a function block 574. Otherwise, control is passed to a function block 576.

The function block 574 parses the camera parameters, and passes control to the function block 576.

The function block 576 continues decoding, and passes control to an end block 599.

The function block 525 parses is_base_view_flag[i] and dependency_update_flag, and passes control to a decision block 530. The decision block 530 determines whether or not dependency_update_flag is equal to zero. If so, then control is passes to a function block 532. Otherwise, control is passed to a decision block 535.

The function block 532 increments i by one, and returns control to the decision block 515.

The decision block 535 determines whether or not j is less than or equal to N. If so, then control is passed to a function block 540. Otherwise, control is passes to a function block 537.

The function block 540 parses anchor_picture_dependency_maps[i][j], and passes control to a decision block 545. The decision block 545 determines whether or not non_anchor_picture_dependency_maps[i][j] is equal to one. If so, then control is passed to a function block 550. Otherwise, control is passes to a function block 547.

The function block 550 parses the non_anchor_picture_dependency_maps[i][j], and passes control to the function block 547.

The function block 547 increments j by one, and returns control to the decision block 535.

The function block 537 increments i by one, and returns control to the function block 515.

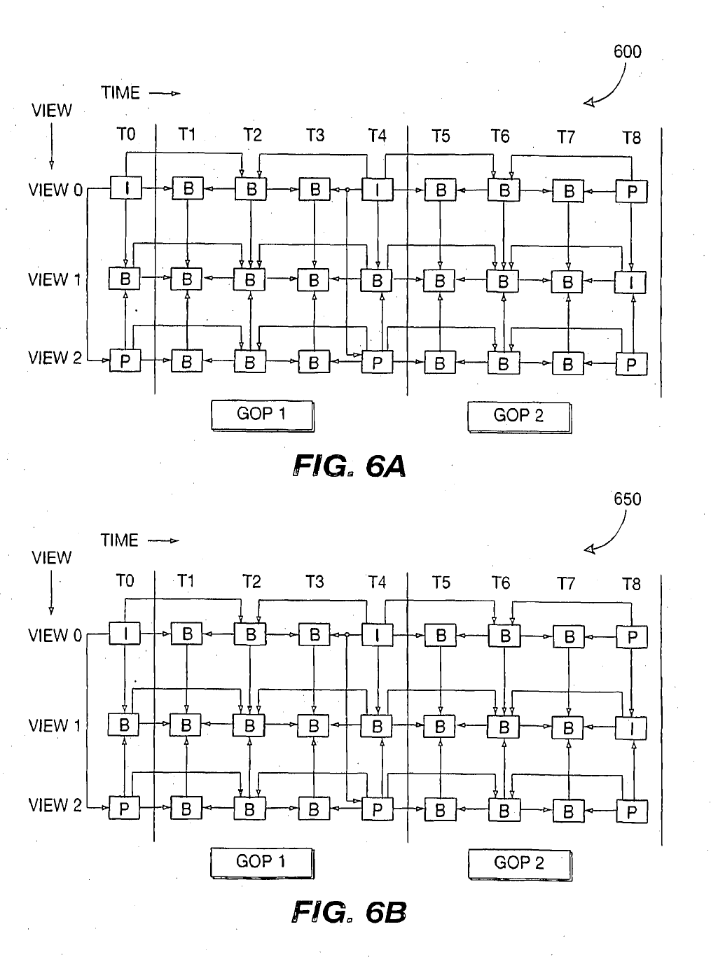

The preceding embodiments provide efficient methods to address random access without the need for buffering. These methods work well in cases where the dependency structure does not change from one Group of Pictures (GOP) to another. However, if a case arises where the dependency does change, then the methods may break down. This concept is illustrated in FIGS. 6A and 6B.

Turning to FIG. 6A, a diagram illustrating an exemplary dependency change in non-anchor frames that have the same dependency as a later anchor slot is indicated generally by the reference numeral 600. Turning to FIG. 6B, a diagram illustrating an exemplary dependency change in non-anchor frame that have the same dependency as a previous anchor slot is indicated generally by the reference numeral 650.

As shown in FIG. 6A, in GOP 1 the I-picture (intra coded picture) is located in the view 0 but in GOP 2 the location of the I-picture changes to view 1. It can be clearly seen that the dependency structure of the anchor frames in GOP 1 is different from that of GOP 2. It can also be seen that the frames between the two anchor slots has the same dependency structure as that of the anchor frame of GOP 2. As a result, the VPS for the two GOPs will be different. If random access is initiated in the part where the dependency structure has changed from the previous dependency structure and if no buffering is done, then the previous dependency structure will be used to discard the frames that are not needed for the random access view. This is a problem since the dependency structures are different in the two GOPs.

Therefore, in accordance with various other embodiments of the present principles, we propose methods and apparatus different from that proposed in the preceding embodiments in that the latter embodiments described herein below address cases where the dependency changes over time between different GOPs. The dependency structure can change due to several reasons. One reason is the change in the I-picture location from one view to another over a different GOP. This is illustrated in FIGS. 6A and 6B described herein above. In this case the dependency structure of the next GOP is different from that of the previous GOP. This information needs to be conveyed using a new View Parameter Set.

In particular, we propose two exemplary methods to address this changing dependency structure. In a first method, we take into consideration the dependency structure between the two anchor time slots. In the first method, we determine the frames needed to decode a subset of views on the basis of the dependency structure between the times when the dependency changes from one anchor time slot to another. In the second method, we combine the dependency structure of the GOP in which the dependency has changed with the previous dependency structure to obtain a new dependency map that will address the above-identified problem. These two methods will now be further described in detail. Of course, it is to be appreciated that, given the teachings of the present principles provided herein, one of ordinary skill in this and related arts will contemplate these and various other methods and variations thereof for encoding and/or decoding multi-view video content when the dependency changes over time between different Groups Of Pictures, while maintaining the spirit of the present principles.

In the first method, we solve the above issue by taking into consideration the dependency structure of the frames in between the two anchor slots.

The selection of the dependency structure is determined at the encoder. When there is a change in dependency structure between two GOPs, the frames in between the two anchor slots can have the same dependency structure of the previous anchor slot or the next anchor slot. Again, this is determined by the encoder. The two different options are illustrated in FIGS. 6A and 6B.

In order to decode a subset of a view or for random access of a particular view, it is useful to know the dependency structure in between these two anchor slots. If this information is known ahead of time, then it makes it easier to determine which frames are needed for decoding without additional processing.

In order to determine this dependency structure between two anchor slots, we propose a new syntax element to indicate whether these non-anchor frames follow the dependency structure of the previous anchor slot or the next anchor slot in display order. This signal/flag should be present at a high level in the bitstream. This information can be conveyed in-band or out-of-band.

In an exemplary embodiment, this signal/flag can be present in the View Parameter Set or Sequence Parameter Set of the MVC extension of the MPEG-4 AVC standard. An exemplary signal/flag is shown in TABLES 5A and 5B.

TABLE 5A

| view_parameter_set_rbsp( ) { | C | Descriptor |
|---|---|---|
| view_parameter_set_id | 0 | ue(v) |
| number_of_views_minus_1 | 0 | ue(v) |
| avc_compatible_view_id | 0 | ue(v) |
| previous_anchor_dep_struct_flag | 0 | u(1) |
| ....... | | |
| } | | |

TABLE 5B

| sequence_parameter_set_rbsp( ) { | C | Descriptor |
|---|---|---|
| profile_idc | 0 | u(8) |
| ..... | 0 | ue(v) |
| if(profile_idc == MULTI_VIEW) | 0 | ue(v) |
| previous_anchor_dep_struct_flag | 0 | u(1) |
| ....... | | |
| } | | |

In the instant embodiment, previous_anchor_dep_struct_flag equal to 0 indicates that the non-anchor frames follow the dependency structure of the next anchor slot, and previous_anchor_dep_struct_flag equal to 1 indicates that the non-anchor frames follows the dependency structure of the previous anchor slot.

The process of random access or subset view decoding will depend on this flag. When this flag is set to 1, it is conveyed to the decoder that the non-anchor frames will follow the dependency structure of the previous anchor slot in display order as shown in FIG. 6B.

When this is the case, the decoder knows that it does not need to buffer any frames. In one exemplary embodiment, the method performed by the decoder for a random access of a view is as follows, and can also be seen from FIG. 6B. We presume that random access is required for view 2 and time T6.

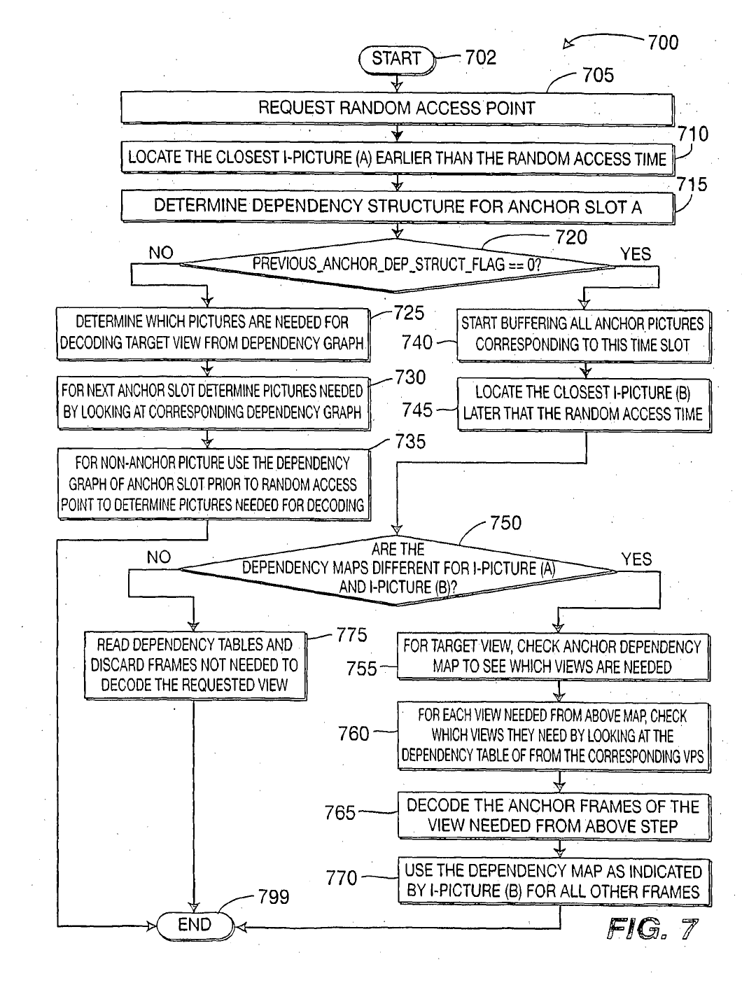

The first method directed to the case when the dependency structure changes from one GOP to another GOP will be now be described generally, following by a further description of the same with respect to FIG. 7. The following steps are described with respect to an imposed ordering. However, it is to be appreciated that the ordering is for purposes of illustration and clarity. Accordingly, given the teachings of the present principles provided herein, such ordering may be re-arranged and/or otherwise modified, as readily determined by one of ordinary skill in this and related arts, while maintaining the scope of the present principles.

In a first step, for a target view (view 2), locate the closest I-picture earlier than T6. In a second step, determine the dependency structure for the anchor slot corresponding to this I-picture by looking at TABLE 7A. In a third step, if the previous_anchor_dep_struct_flag is determined to be set to 0, then buffer the anchor picture in this slot, otherwise, from TABLE 7A determine which pictures need to be decoded. In a fourth step, for the anchor slot of GOP 2, look at TABLE 7C to determine which pictures are needed for decoding the target view. If previous_anchor_dep_struct_flag is equal to 0, then follow the fifth, sixth, and seventh steps herein after to determine which frames from the previous anchor slot need to be decoded; otherwise, continue onto the eighth step. In the fifth step, for target view (view 2), check in the anchor dependency table (TABLE 6C) which views (view 1) are needed. In the sixth step, for each view (view 1) needed for target view (view 2), check which views (view 0, view 2) are needed by looking at the dependency table of that VPS (TABLE 6A). In a seventh step, decode the anchor frames from the views (view 0, view 2) if those frames point to the View Parameter Set (VPS) of the I-picture that is prior in time to the target view/time. In the eight step, to determine which pictures are needed for all the non-anchors, if previous_anchor_dep_struct_flag is set to 1, then use the previous anchor slot's dependency structure to determine which frames need to be decoded for target view; otherwise, use the next anchor slot's dependency structure.

TABLE 6A

| | j | | |
|---|---|---|---|
| i | View 1 | View 2 | View 3 |
| View 0 | 0 | 1 | 1 |
| View 1 | 0 | 0 | 0 |
| View 2 | 0 | 1 | 0 |

TABLE 6B

| | j | | |
|---|---|---|---|
| i | View 1 | View 2 | View 3 |
| View 0 | 0 | 1 | 0 |
| View 1 | 0 | 0 | 0 |
| View 2 | 0 | 1 | 0 |

TABLE 6C

| | j | | |
|---|---|---|---|
| i | View 1 | View 2 | View 3 |
| View 0 | 0 | 0 | 0 |
| View 1 | 1 | 0 | 1 |
| View 2 | 0 | 0 | 0 |

TABLE 6D

| | j | | |
|---|---|---|---|
| i | View 1 | View 2 | View 3 |
| View 0 | 0 | 0 | 0 |
| View 1 | 1 | 0 | 1 |
| View 2 | 0 | 0 | 0 |

TABLE 7A

| | j | | |
|---|---|---|---|
| i | View 1 | View 2 | View 3 |
| View 0 | 0 | 1 | 1 |
| View 1 | 0 | 0 | 0 |
| View 2 | 0 | 1 | 0 |

TABLE 7B

| | j | | |
|---|---|---|---|
| i | View 1 | View 2 | View 3 |
| View 0 | 0 | 1 | 0 |
| View 1 | 0 | 0 | 0 |
| View 2 | 0 | 1 | 0 |

TABLE 7C

| | j | | |
|---|---|---|---|
| i | View 1 | View 2 | View 3 |
| View 0 | 0 | 0 | 0 |
| View 1 | 1 | 0 | 1 |
| View 2 | 0 | 0 | 0 |

TABLE 7D

| | j | | |
|---|---|---|---|
| i | View 1 | View 2 | View 3 |
| View 0 | 0 | 1 | 0 |
| View 1 | 0 | 0 | 0 |
| View 2 | 0 | 1 | 0 |

Turning to FIG. 7, an exemplary method for decoding multi-view video content using a random access point is indicated generally by the reference numeral 700.

The method includes a start block 702 that passes control to a function block 705. The function block 705 requests a random access point, and passes control to a function block 710. The function block 710 locates the closest I-picture (A) earlier than the random access time, and passes control to a function block 715. The function block 715 determines the dependency structure for anchor slot A, and passes control to a decision block 720. The decision block 720 determines whether or not previous_anchor_dep_struct_flag is equal to zero. If so, then control is passed to a function block 740. Otherwise, control is passed to a function block 725.

The function block 740 starts buffering all anchor pictures corresponding to this time slot, and passes control to a function block 745. The function block 745 locates the closest I-picture (B) later than the random access time, and passes control to a decision block 750. The decision block 750 determines whether or not the dependency maps are different for I-picture (A) and I-picture (B). If so, then control is passed to a function block 755. Otherwise, control is passed to a function block 775.

The function 755, for a target view, checks the anchor dependency map to see which views are needed, and passes control to a function block 760. The function block 760, for each view needed from the above map, checks which views they need by looking at the dependency table from the corresponding View Parameter Set (VPS), and passes control to a function block 765. The function block 765 decodes the anchor frames of the view needed as identified by function block 760, and passes control to the function block 770. The function block 770 uses the dependency map as indicated by the I-picture (B) for all other frames, and passes control to an end block 799.

The function block 725 determines which pictures are needed for decoding the target view from the dependency graph, and passes control to a function block 730. The function block 730, for the next anchor slot, determines the pictures needed by looking at the corresponding dependency graph, and passes control to a function block 735. The function block 735, for a non-anchor picture, uses the dependency graph of the anchor slot prior to the random access point to determine the pictures needed to decoding, and passes control to the end block 799.

The function block 775 reads the dependency tables and discards the frames not needed to decode the requested view, and passes control to the end block 799.

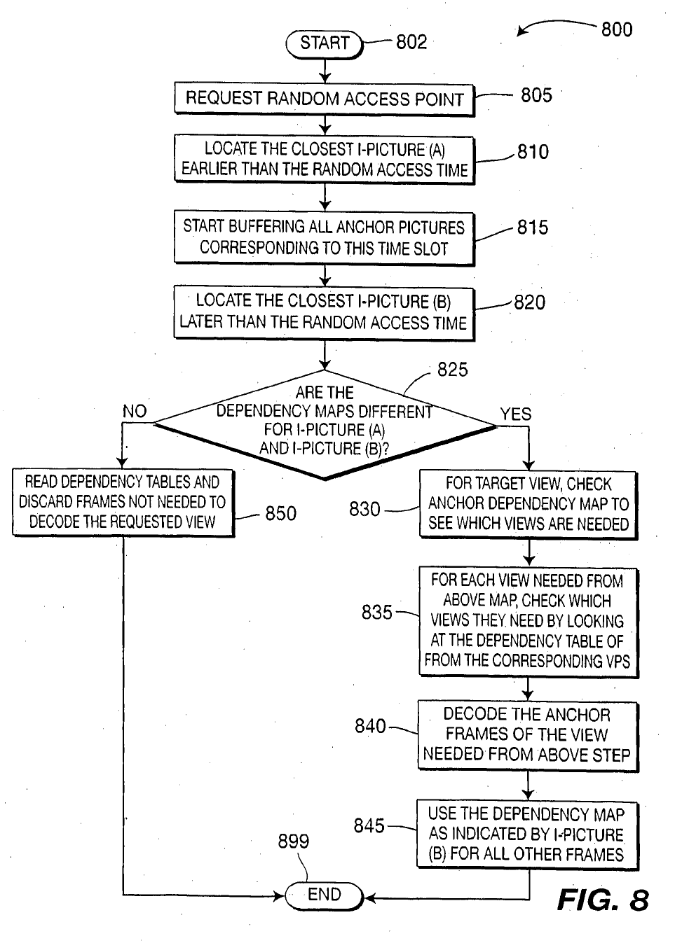

The second method directed to the case when the dependency structure changes from one GOP to another GOP will be now be described generally, following by a further description of the same with respect to FIG. 8. The following steps are described with respect to an imposed ordering. However, it is to be appreciated that the ordering is for purposes of illustration and clarity. Accordingly, given the teachings of the present principles provided herein, such ordering may be re-arranged and/or otherwise modified, as readily determined by one of ordinary skill in this and related arts, while maintaining the scope of the present principles.

As described above, in the first method, we solve the above issue of the dependency structure changing from one GOP to another GOP by combining the dependency structures of the two GOPs in a way that the correct frames are discarded. The process of random access is illustrated using FIG. 6A.

The dependency maps for GOP 1 and GOP 2 for anchor and non-anchor pictures are shown in TABLES 6A, 6B, 6C and 6D.

Let us assume that the target view is view 2 and the target time is T6. For random access to this view and time, we must locate the closest I-picture that is prior (in time only) to the current target view/time target. Note the VPS-ID of this I-picture and buffer all the anchor pictures at this time interval. As soon as the next I-picture that is later (in time only) arrives, check if the VPS-ID is the same as the previous I-picture or not. If the IDs are the same then use the dependency structure as indicated in this VPS to decide which frames to keep and which to discard.

If the VPS IDs are different, then the following steps should be carried out. In a first step, for a target view (view 2), check in the anchor dependency table (TABLE 6C) which views (view 1) are needed. In a second step, for each view (view 1) needed for the target view (view 2), check which views (view 0, view 2) are needed by looking at the dependency table of that VPS (TABLE 6A). In a third step, decode the anchor frames from the views (view 0, view 2) if those frames point to the VPS of the I-picture that is prior in time to the target view/time. In a fourth step, for all the frames that point to or use a VPS-ID that is the same as that of an I-picture that is later in time to the target view/time, use the dependency map that is indicated in that VPS (TABLE 6C, 6D).

The second method ensures that even when the position of the I-picture changes between views, random access can still be done in an efficient manner. We only need to buffer the anchor pictures corresponding to the closest I-picture that is earlier than the random access point in time.

Turning to FIG. 8, another exemplary method for decoding multi-view content using a random access point is indicated generally by the reference numeral 800.

The method 800 includes a start block 802 that passes control to a function block 805. The function block 805 requests a random access point, and passes control to a function block 810. The function block 810 locates the closest I-picture (A) earlier than the random access time, and passes control to a function block 815. The function block 815 starts buffering all anchor pictures corresponding to this time slot, and passes control to a function block 820. The function block 820 locates the closest I-picture (B) later than the random access time, and passes control to a decision block 825. The decision block 825 determines whether or not the dependency maps are different for I-picture (A) and I-picture (B). If so, the control is passed to a function block 830. Otherwise, control is passed to a function block 850.

The function block 830, for a target view, checks the anchor dependency map to see which views are needed, and passes control to a function block 835. The function block 835, for each view needed from the above map, checks which views they need by looking at the dependency table from the corresponding View Parameter Set (VPS), and passes control to a function block 840. The function block 840 decodes the anchor frames of the view needed as identified by function block 835, and passes control to a function block 845. The function block 845 uses the dependency map as indicated by the I-picture (B) for all other frames, and passes control to an end block 899.

The function block 850 reads the dependency tables and discards frames not needed to decode the requested view, and passes control to the end block 899.

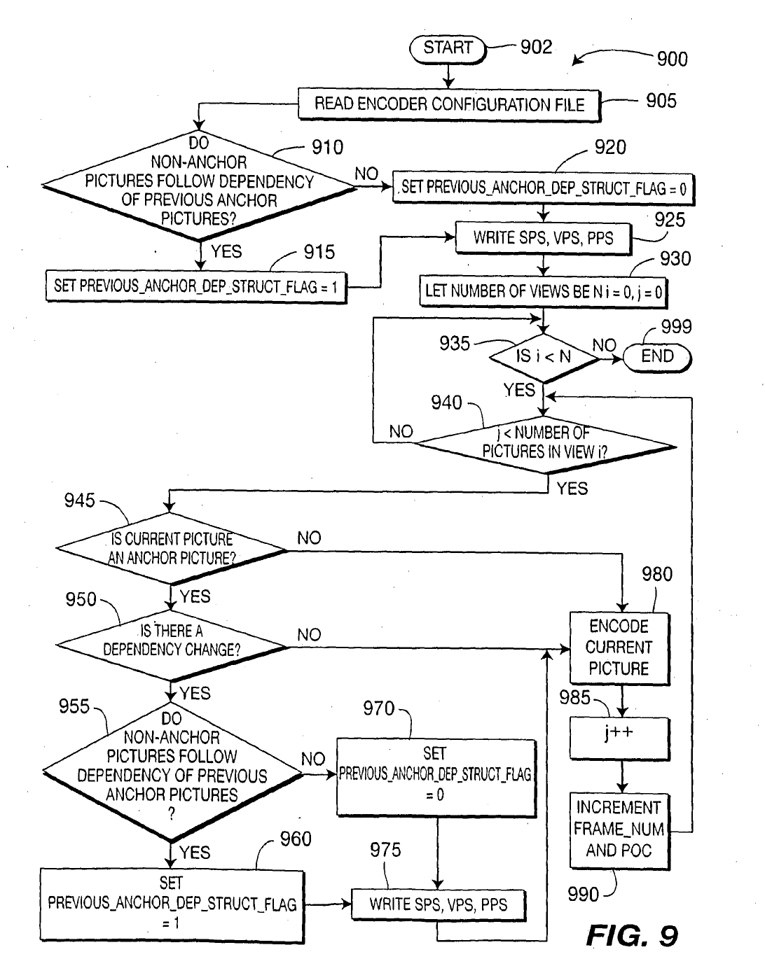

Turning to FIG. 9, an exemplary method for encoding multi-view video content is indicated generally by the reference numeral 900.

The method 900 includes a start block 902 that passes control to a function block 905. The function block 905 reads the encoder configuration file, and passes control to a decision block 910. The decision block 910 determines whether or not the non-anchor pictures follow the dependency of the previous anchor pictures. If so, then control is passed to a function block 915. Otherwise, control is passed to a function block 920.

The function block 915 sets previous_anchor_dep_struct_flag equal to one, and passes control to a function block 925.

The function block 920 sets previous_anchor_dep_flag equal to zero, and passes control to a function block 925.

The function block 925 writes the Sequence Parameter Set (SPS), the View Parameter Set (VPS), and/or the Picture Parameter Set (PPS), and passes control to a function block 930. The function block 930 lets the number of views be N, initializes variables i and j to be equal to zero, and passes control to a decision block 935. The decision block 935 determines whether or not i is less than N. If so, the control is passed to a decision block 940. Otherwise, control is passed to an end block 999.

The decision block 940 determines whether or not j is less than a number of pictures in view i. If so, then control is passed to a decision block 945. Otherwise, control is returned to the decision block 935.

The decision block 945 determines whether or not the current picture is an anchor picture. If so, then control is passed to a decision block 950. The decision block 950 determines whether or not there is a dependency change. If so, then control is passed to a decision block 955. Otherwise, control is passed to a function block 980.

The decision block 955 determines whether or not the non-anchor pictures follow the dependency of the previous anchor pictures. If so, the control is passed to a function block 960. Otherwise, control is passed to a function block 970.

The function block 960 sets previous_anchor_dep_struct_flag equal to one, and passes control to a function block 975.

The function block 970 sets previous_anchor_dep_struct_flag equal to zero, and passes control to a function block 975.

The function block 975 writes the Sequence Parameter Set (SPS), View Parameter Set (VPS), and/or Picture Parameter Set (PPS), and passes control to the function block 980.

The function block 980 encodes the current picture, and passes control to a function block 985. The function block 985 increments the variable j, and passes control to a function block 990. The function block 990 increments frame_num and the Picture Order Count (POC), and returns control to the decision block 940.

A description will now be given of some of the many attendant advantages/features of the present invention, some of which have been mentioned above. For example, one advantage/feature is an apparatus that includes an encoder for encoding anchor and non-anchor pictures for at least two views corresponding to multi-view video content. A dependency structure of each non-anchor picture in a set of non-anchor pictures disposed between a previous anchor picture and a next anchor picture in display order in at least one of the at least two views is the same as the previous anchor picture or the next anchor picture in display order.

Another advantage/feature is the apparatus having the encoder as described above, wherein the encoder signals the dependency structure at least one of in-band and out-of-band.

Yet another advantage/feature is the apparatus having the encoder as described above, wherein the encoder signals the dependency structure using a high level syntax.

Moreover, another advantage/feature is the apparatus having the encoder that signals the dependency structure using the high level syntax as described above, wherein the dependency structure is signaled in at least one of a Sequence Parameter Set, a View Parameter Set, and a Picture Parameter Set.

Further, another advantage/feature is the apparatus having the encoder that signals the dependency structure using the high level syntax as described above, wherein the dependency structure is signaled using a flag.

Also, another advantage/feature is the apparatus having the encoder that signals the dependency structure using the flag as described above, wherein the flag is denoted by a previous_anchor_dep_struct_flag syntax element.

Additionally, another advantage/feature is the apparatus having the encoder that signals the dependency structure using the high level syntax as described above, wherein the dependency structure is used to determine which other pictures in any of the at least two views are to be used to at least partially decode the set of non-anchor pictures.

Moreover, another advantage/feature is the apparatus having the encoder that signals the dependency structure using the high level syntax as described above, wherein the dependency structure is used to determine which other pictures in the at least two views are to be used for decoding the set of non-anchor pictures during a random access of the at least one of the at least two views.

Also, another advantage/feature is the apparatus having a decoder for decoding anchor and non-anchor pictures for at least two views corresponding to multi-view video content. A dependency structure of each non-anchor picture in a set of non-anchor pictures disposed between a previous anchor picture and a next anchor picture in display order in at least one of the at least two views is the same as the previous anchor picture or the next anchor picture in display order.

Additionally, another advantage/feature is the apparatus having the decoder as described above, wherein the decoder receives the dependency structure at least one of in-band and out-of-band.

Moreover, another advantage/feature is the apparatus having the decoder as described above, wherein the decoder determines the dependency structure using a high level syntax.

Further, another advantage/feature is the apparatus having the decoder that determines the dependency structure using the high level syntax as described above, wherein the dependency structure is determined using at least one of a Sequence Parameter Set, a View Parameter Set, and a Picture Parameter Set.

Also, another advantage/feature is the apparatus having the decoder that determines the dependency structure using the high level syntax as described above, wherein the dependency structure is determined using a flag.

Additionally, another advantage/feature is the apparatus having the decoder that determines the dependency structure using the flag as described above, wherein the flag is denoted by a previous_anchor_dep_struct_flag syntax element.

Moreover, another advantage/feature is the apparatus having the decoder that determines the dependency structure using the high level syntax as described above, wherein the dependency structure is used to determine which other pictures in any of the at least two views are to be used to at least partially decode the set of non-anchor pictures.

Further, another advantage/feature is the apparatus having the decoder that determines the dependency structure using the high level syntax as described above, wherein the dependency structure is used to determine which other pictures in the at least two views are to be used for decoding the set of non-anchor pictures during a random access of the at least one of the at least two views.

Also, another advantage/feature is the apparatus having the decoder as described above, wherein the decoder determines which of the anchor pictures in the at least two views to buffer for a random access of the at least one of the at least two views based on whether the dependency structure follows the previous anchor picture or the next anchor picture in display order.

Additionally, another advantage/feature is the apparatus having the decoder that determines which of the anchor pictures in the at least two views to buffer for the random access as described above, wherein the decoder selects the anchor pictures disposed prior to a random access point for buffering, when the dependency structure of the non-anchor pictures in the set of non-anchor pictures is the same as the anchor pictures disposed subsequent to the random access point in display order.

Moreover, another advantage/feature is the apparatus having the decoder that determines which of the anchor pictures in the at least two views to buffer for the random access as described above, wherein the decoder omits from buffering the anchor pictures disposed prior to a random access point, when the dependency structure of the non-anchor pictures in the set of non-anchor pictures is the same as the anchor pictures disposed prior to the random access point in display order.

Further, another advantage/feature is an apparatus having a decoder for decoding at least two views corresponding to multi-view video content from a bitstream. At least two Groups of Pictures corresponding to one or more of the at least two views have a different dependency structure. The decoder selects pictures in the at least two views that are required to be decoded for a random access of at least one of the at least two views based upon at least one dependency map.

Also, another advantage/feature is the apparatus having the decoder as described above, wherein the random access begins at a closest intra coded picture that is earlier in display order than the random access.

Additionally, another advantage/feature is the apparatus having the decoder and wherein the random access begins at a closest intra coded picture that is earlier in display order than the random access as described above, wherein the bitstream includes anchor pictures and non-anchor pictures, and the decoder buffers the anchor pictures, in the at least two views, that temporally correspond to the closest intra coded picture that is earlier than the random access.

Moreover, another advantage/feature is the apparatus having the decoder as described above, wherein the random access begins at a closest intra coded picture that is later than the random access.

Further, another advantage/feature is the apparatus having the decoder as described above, wherein the at least one dependency map includes dependency maps of earlier intra coded pictures and later intra coded pictures with respect to the random access, and the decoder selects the required pictures by comparing the dependency maps of the earlier intra coded pictures and the later intra coded pictures.

Also, another advantage/feature is the apparatus having the decoder that selects the required pictures by comparing the dependency maps as described above, wherein the dependency maps of the earlier intra coded pictures and the later intra coded pictures are the same.

Additionally, another advantage/feature is the apparatus having the decoder that selects the required pictures by comparing the dependency maps that are the same as described above, wherein any of the dependency maps of the earlier intra coded pictures and the later intra coded pictures is used to determine the required pictures.

Moreover, another advantage/feature is the apparatus having the decoder that selects the required pictures by comparing the dependency maps as described above, wherein the dependency maps of the earlier intra coded pictures and the later intra coded pictures are different.

Further, another advantage/feature is the apparatus having the decoder that selects the required pictures by comparing the dependency maps that are different as described above, wherein the at least one dependency map includes at least one anchor picture dependency map, and the decoder checks the at least one anchor picture dependency map to determine which of the at least two views does the at least one of the at least two views depend upon.

Also, another advantage/feature is the apparatus having the decoder that selects the required pictures by comparing the dependency maps that are different as described above, wherein for each of the at least two views from which the at least one of the at least two views depends, the decoder checks dependency tables corresponding thereto.

Additionally, another advantage/feature is the apparatus having the decoder that selects the required pictures by comparing the dependency maps that are different and the dependency tables as described above, wherein the anchor pictures are decoded from each of the at least two views from which the at least one of the at least two views depends.

Moreover, another advantage/feature is the apparatus having the decoder that selects the required pictures by comparing the dependency maps that are different as described above, wherein the decoder determines whether any particular pictures that use a same dependency map as the later intra coded pictures are required to be decoded for the random access, based upon a dependency map formed from a combination of a changed dependency structure for one of the at least two Groups Of Pictures and an unchanged dependency structure for another one of the at least two Groups of Pictures.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
an encoder for encoding anchor and non-anchor pictures for at least two views corresponding to multi-view video content, wherein a dependency structure of each non-anchor picture in a set of non-anchor pictures disposed between a previous anchor picture and a next anchor picture in display order in at least one of the at least two views is the same as the previous anchor picture or the next anchor picture in display order.

2. The apparatus of claim 1, wherein said encoder signals the dependency structure at least one of in-band and out-of-band.

3. The apparatus of claim 1, wherein said encoder signals the dependency structure using a high level syntax.

4. The apparatus of claim 3, wherein the dependency structure is signaled in at least one of a Sequence Parameter Set, a View Parameter Set, and a Picture Parameter Set.

5. The apparatus of claim 3, wherein the dependency structure is signaled using a flag.

6. The apparatus of claim 5, wherein the flag is denoted by a previous_anchor_dep_struct_flag syntax element.

7. The apparatus of claim 3, wherein the dependency structure is used to determine which other pictures in any of the at least two views are to be used to at least partially decode the set of non-anchor pictures.

8. The apparatus of claim 3, wherein the dependency structure is used to determine which other pictures in the at least two views are to be used for decoding the set of non-anchor pictures during a random access of the at least one of the at least two views.

9. A method, comprising:
encoding anchor and non-anchor pictures for at least two views corresponding to multi-view video content, wherein a dependency structure of each non-anchor picture in a set of non-anchor pictures disposed between a previous anchor picture and a next anchor picture in display order in at least one of the at least two views is the same as the previous anchor picture or the next anchor picture in display order.

10. The method of claim 9, wherein said encoding step comprises signaling the dependency structure at least one of in-band and out-of-band.

11. The method of claim 9, wherein said encoding step comprises signaling the dependency structure using a high level syntax.

12. The method of claim 11, wherein the dependency structure is signaled in at least one of a Sequence Parameter Set, a View Parameter Set, and a Picture Parameter Set.

13. The method of claim 11, wherein the dependency structure is signaled using a flag.

14. The method of claim 13, wherein the flag is denoted by a previous_anchor_dep_struct_flag syntax element.

15. The method of claim 11, wherein the dependency structure is used to determine which other pictures in any of the at least two views are to be used to at least partially decode the set of non-anchor pictures.

16. The method of claim 11, wherein the dependency structure is used to determine which other pictures in the at least two views are to be used for decoding the set of non-anchor pictures during a random access of the at least one of the at least two views.

17. An apparatus, comprising:
a decoder for decoding anchor and non-anchor pictures for at least two views corresponding to multi-view video content, wherein a dependency structure of each non-anchor picture in a set of non-anchor pictures disposed between a previous anchor picture and a next anchor picture in display order in at least one of the at least two views is the same as the previous anchor picture or the next anchor picture in display order.

18. The apparatus of claim 17, wherein said decoder receives the dependency structure at least one of in-band and out-of-band.

19. The apparatus of claim 17, wherein said decoder determines the dependency structure using a high level syntax.

20. The apparatus of claim 19, wherein the dependency structure is determined using at least one of a Sequence Parameter Set, a View Parameter Set, and a Picture Parameter Set.

21. The apparatus of claim 19, wherein the dependency structure is determined using a flag.

22. The apparatus of claim 21, wherein the flag is denoted by a previous_anchor_dep_struct_flag syntax element.

23. The apparatus of claim 19, wherein the dependency structure is used to determine which other pictures in any of the at least two views are to be used to at least partially decode the set of non-anchor pictures.

24. The apparatus of claim 19, wherein the dependency structure is used to determine which other pictures in the at least two views are to be used for decoding the set of non-anchor pictures during a random access of the at least one of the at least two views.

25. The apparatus of claim 17, wherein said decoder determines which of the anchor pictures in the at least two views to buffer for a random access of the at least one of the at least two views based on whether the dependency structure follows the previous anchor picture or the next anchor picture in display order.

26. The apparatus of claim 25, wherein said decoder selects the anchor pictures disposed prior to a random access point for buffering, when the dependency structure of the non-anchor pictures in the set of non-anchor pictures is the same as the anchor pictures disposed subsequent to the random access point in display order.

27. The apparatus of claim 25, wherein said decoder omits from buffering the anchor pictures disposed prior to a random access point, when the dependency structure of the non-anchor pictures in the set of non-anchor pictures is the same as the anchor pictures disposed prior to the random access point in display order.

28. A method, comprising:
decoding anchor and non-anchor pictures for at least two views corresponding to multi-view video content, wherein a dependency structure of each non-anchor picture in a set of non-anchor pictures disposed between a previous anchor picture and a next anchor picture in display order in at least one of the at least two views is the same as the previous anchor picture or the next anchor picture in display order.

29. The method of claim 28, wherein said decoding step comprises receiving the dependency structure at least one of in-band and out-of-band.

30. The method of claim 28, wherein said decoding step comprises determining the dependency structure using a high level syntax.

31. The method of claim 30, wherein the dependency structure is determined using at least one of a Sequence Parameter Set, a View Parameter Set, and a Picture Parameter Set.

32. The method of claim 30, wherein the dependency structure is determined using a flag.

33. The method of claim 32, wherein the flag is denoted by a previous_anchor_de1p_struct_flag syntax element.

34. The method of claim 30, wherein the dependency structure is used to determine which other pictures in any of the at least two views are to be used to at least partially decode the set of non-anchor pictures.

35. The method of claim 30, wherein the dependency structure is used to determine which other pictures in the at least two views are to be used for decoding the set of non-anchor pictures during a random access of the at least one of the at least two views.

36. The method of claim 28, wherein said decoding step comprises determining which of the anchor pictures in the at least two views to buffer for a random access of the at least one of the at least two views based on whether the dependency structure follows the previous anchor picture or the next anchor picture in display order.

37. The method of claim 36, wherein said decoding step comprises selecting the anchor pictures disposed prior to a random access point for buffering, when the dependency structure of the non-anchor pictures in the set of non-anchor pictures is the same as the anchor pictures disposed subsequent to the random access point in display Order.

38. The method of claim 36, wherein said decoding step comprises omitting from buffering the anchor pictures disposed prior to a random access point, when the dependency structure of the non-anchor pictures in the set of non-anchor pictures is the same as the anchor pictures disposed prior to the random access point in display order.

39. An apparatus, comprising:
a decoder for decoding at least two views corresponding to multi-view video content from a bitstream, at least two Groups of Pictures corresponding to one or more of the at least two views having a different dependency structure, wherein said decoder selects pictures in the at least two views that are required to be decoded for a random access of at least one of the at least two views based upon at least one dependency map.

40. The apparatus of claim 39, wherein the random access begins at a closest intra coded picture that is earlier in display order than the random access.

41. The apparatus of claim 40, wherein the bitstream includes anchor pictures and non-anchor pictures, and said decoder buffers the anchor pictures, in the at least two views, that temporally correspond to the closest intra coded picture that is earlier than the random access.

42. The apparatus of claim 39, wherein the random access begins at a closest intra coded picture that is later than the random access.

43. The apparatus of claim 39, wherein the at least one dependency map includes dependency maps of earlier intra coded pictures and later intra coded pictures with respect to the random access, and said decoder selects the required pictures by comparing the dependency maps of the earlier intra coded pictures and the later intra coded pictures.

44. The apparatus of claim 43, wherein the dependency maps of the earlier intra coded pictures and the later intra coded pictures are the same.

45. The apparatus of claim 44, wherein any of the dependency maps of the earlier intra coded pictures and the later intra coded pictures is used to determine the required pictures.

46. The apparatus of claim 43, wherein the dependency maps of the earlier intra coded pictures and the later intra coded pictures are different.

47. The apparatus of claim 46, wherein the at least one dependency map includes at least one anchor picture dependency map, and said decoder checks the at least one anchor picture dependency map to determine which of the at least two views does the at least one of the at least two views depend upon.

48. The apparatus of claim 47, wherein for each of the at least two views from which the at least one of the at least two views depends, said decoder checks dependency tables corresponding thereto.

49. The apparatus of claim 48, wherein the anchor pictures are decoded from each of the at least two views from which the at least one of the at least two views depends.

50. The apparatus of claim 47, wherein said decoder determines whether any particular pictures that use a same dependency map as the later intra coded pictures are required to be decoded for the random access, based upon a dependency map formed from a combination of a changed dependency structure for one of the at least two Groups Of Pictures and an unchanged dependency structure for another one of the at least two Groups of Pictures.

51. A method, comprising:
decoding at least two views corresponding to multi-view video content from a bitstream, at least two Groups of Pictures corresponding to one or more of the at least two views having a different dependency structure, wherein said decoding step selects pictures in the at least two views that are required to be decoded for a random access of at least one of the at least two views based upon at least one dependency map.

52. The method of claim 51, wherein the random access begins at a closest intra coded picture that is earlier in display order than the random access.

53. The method of claim 52, wherein the bitstream includes anchor pictures and non-anchor pictures, and said decoding step comprises buffering the anchor pictures, in the at least two views, that temporally correspond to the closest intra coded picture that is earlier than the random access.

54. The method of claim 51, wherein the random access begins at a closest intra coded picture that is later than the random access.

55. The method of claim 51, wherein the at least one dependency map includes dependency maps of earlier intra coded pictures and later intra coded pictures with respect to the random access, and said decoding step selects the required pictures by comparing the dependency maps of the earlier intra coded pictures and the later intra coded pictures.

56. The method of claim 55, wherein the dependency maps of the earlier intra coded pictures and the later intra coded pictures are the same.

57. The method of claim 56, wherein any of the dependency maps of the earlier intra coded pictures and the later intra coded pictures is used to determine the required pictures.

58. The method of claim 55, wherein the dependency maps of the earlier intra coded pictures and the later intra coded pictures are different.

59. The method of claim 58, wherein the at least one dependency map includes at least one anchor picture dependency map, and said decoding step comprises checking the at least one anchor picture dependency map to determine which of the at least two views does the at least one of the at least two views depend upon.

60. The method of claim 59, wherein for each of the at least two views from which the at least one of the at least two views depends said decoding step comprises checking dependency tables corresponding thereto.

61. The method of claim 60, wherein the anchor pictures are decoded from each of the at least two views from which the at least one of the at least two views depends.

62. The method of claim 59, wherein said decoding step comprises determining whether any particular pictures that use a same dependency map as the later intra coded pictures are required to be decoded for the random access based upon a dependency map formed from a combination of a changed dependency structure for one of the at least two Groups Of Pictures and an unchanged dependency structure for another one of the at least two Groups of Pictures.

63. A video signal structure for video encoding, comprising:
anchor and non-anchor pictures encoded for at least two views corresponding to multi-view video content, wherein a dependency structure of each non-anchor picture in a set of non-anchor pictures disposed between a previous anchor picture and a next anchor picture in display order in at least one of the at least two views is the same as the previous anchor picture or the next anchor picture in display order.

64. A storage media having video signal data encoded thereupon, comprising:
anchor and non-anchor pictures encoded for at least two views corresponding to multi-view video content, wherein a dependency structure of each non-anchor picture in a set of non-anchor pictures disposed between a previous anchor picture and a next anchor picture in display order in at least one of the at least two views is the same as the previous anchor picture or the next anchor picture in display order.
